(19) United States
(12) Patent Application Publication
(10) Pub. No.: US 2025/0306990 A1
(43) Pub. Date: Oct. 2, 2025

(54) SYSTEMS AND METHODS FOR PROCESSING MEDIA DATA FOR DISPLAY BY A MEDIA PLAYER FOR SUBJECT AND EVENT MONITORING

(71) Applicant: One Cup Productions Ltd, Vancouver (CA)

(72) Inventors: Jeffrey Shmigelsky, Vancouver (CA); Gurpreet Singh Sethi, Surrey (CA); Divyansh Sharma, Vancouver (CA)

(21) Appl. No.: 19/092,552

(22) Filed: Mar. 27, 2025

Related U.S. Application Data
(60) Provisional application No. 63/570,699, filed on Mar. 27, 2024.

(30) Foreign Application Priority Data
Mar. 27, 2024 (CA) 3233736

(51) Int. Cl. G06F 9/48; G06F 3/0484

(52) U.S. Cl. CPC G06F 9/4881; G06F 3/0484

(57) ABSTRACT

Various methods and systems for processing media data for displaying a media stream having a plurality of frames and annotations overlaid on the media stream are described herein. The method involves operating at least one processor executing multiple processor threads to: receive by a primary processor thread, media data including the media stream and annotation data associated with the plurality of frames; process, by at least one secondary processor thread, the annotation data for a predefined number of frames starting on a frame corresponding to a selected timestamp, and store the processed annotation data in a buffer associated with the at least one secondary processor thread and display, by the primary processor thread, via a graphical user interface, the media stream and an annotation output associated with at least a subset of the annotation data retrieved from the buffer, starting on the selected timestamp.

### CROSS-REFERENCE TO RELATED APPLICATIONS

This application claims the benefit of priority of U.S. Provisional Patent Application No. 63/570,699 filed Mar. 27, 2024 and Canadian Patent Application No. 3,233,736 filed Mar. 27, 2024. The contents of U.S. Provisional Patent Application No. 63/570,699 and Canadian Patent Application No. 3,233,736 are hereby incorporated by reference in their entirety.

### FIELD

Various embodiments are described herein that generally relate to systems and methods for processing media data, and in particular to systems and methods for processing media data for display on a media player.

### BACKGROUND

Systems that allow for tracking and management of subjects are economically valuable. For example, animal management has important economic and ecological values, and the worldwide population of cattle, for example, ranges from 1 billion to 1.5 billion. Encompassing over 250 breeds, the cattle industry is a massive component of the worldwide economy. Approximately 1.3 billion people depend on cattle for their livelihood.

Thus, there is a great need for efficient systems and methods for tracking and managing livestock. Moreover, scientists, ecological researchers and activists, and governments also require efficient wildlife management systems and methods for tracking wildlife such as bear, elk, wolves, endangered animal species, and the like. Furthermore, veterinarians, pet owners and other individuals raising and caring for animals often also need solutions for managing and monitoring small animals.

Animal management systems incorporating imaging devices have emerged, allowing remote management, monitoring and assessment of animals. Some of these systems allow ranchers and operators to view media captured by imaging devices remotely and asynchronously, and in some cases, view insights obtained or generated by the system.

These systems, however, are resource intensive, since they require the processing, storing, and transmitting of large volumes of data in order to display the media captured and any related insights. There is therefore a need for improved systems and methods for processing media.

### SUMMARY OF VARIOUS EMBODIMENTS

In a broad aspect, in accordance with the teachings herein, there is provided at least one embodiment of a method for processing media data for displaying a media stream comprising a plurality of frames and annotations overlaid on the media stream The method comprises operating at least one processor executing a plurality of processor threads to: receive, by a primary processor thread, media data comprising the media stream and annotation data associated with the plurality of frames; process, by at least one secondary processor thread of a plurality of secondary processor threads, the annotation data for a predefined number of frames of the plurality of frames starting on a frame corresponding to a selected timestamp, and store the processed annotation data in a buffer associated with the at least one secondary processor thread, wherein processing the annotation data comprises at least accessing a subset of the annotation data; and display, by the primary processor thread, via a graphical user interface, the media stream and an annotation output associated with at least a subset of the annotation data retrieved from the buffer, starting on the selected timestamp.

In at least one embodiment, the media data comprises compressed annotation data and the at least one processor is further operable to execute a secondary processor thread of the plurality of secondary processor threads to decompress the media data and transmit the decompressed media data to the primary processor thread, wherein the secondary processor thread decompressing the media data is different from the at least one secondary processor thread processing the annotation data.

In at least one embodiment, the method further comprises operating the at least one processor to: receive, by the primary processor thread, a user selection of the selected timestamp.

In at least one embodiment, the method further comprises operating the at least one processor to: display, by the primary processor thread, via the graphical user interface, a timeline of the media stream and wherein the timestamp is selectable on the timeline.

In at least one embodiment, the predefined number of frames is determined based on one or more of: network resources of a network associated with a system implementing the method, an operating system of the system, the annotation data, a type of the media stream, a frame rate of the media stream a buffer size of the buffer, and a number of frames of the media stream.

In at least one embodiment, the annotation data comprises a plurality of annotation types, and the method further comprises, for each annotation type, processing the annotation data by a separate secondary processor thread.

In at least one embodiment, the method further comprises operating the at least one processor to: receive a selection of one or more types of annotations to be displayed; retrieve, from the buffer the processed annotation data associated with the selected one or more types of annotations; generate the annotation output associated with the selected one or more types of annotations; and display the annotation output.

In at least one embodiment, the method further comprises operating the at least one processor to: determine, by the primary processor thread, that a current displayed frame of the media stream corresponds to a threshold frame, wherein the threshold frame is indicative that fewer than a predetermined number of the predefined number of frames remain to be displayed; and instruct the at least one secondary processor thread processing the annotation data to process the annotation data for the predetermined number of frames beginning on the threshold frame.

In at least one embodiment, the annotation data comprises identification data identifying objects in the plurality of frames, coordinates of the objects and/or one or more classifications associated with the objects.

In at least one embodiment, the annotation data comprises annotation data for a subset of the plurality of frames and processing the annotation data comprises: retrieving the processed annotation data for frames having associated annotation data; and determining annotation data for frames not associated with annotation data based on the processed annotation data for frames having associated annotation data.

In at least one embodiment, the annotation data is generated by an animal assessment system, a ranch management system or a farm management system.

In at least one embodiment, the method further comprises operating the at least one processor to calculate, by one or more secondary processor threads different from the at least one secondary processor thread processing the annotation data, subject analytics for subjects in the media stream based on the annotation data, the subject analytics comprising one or more of: a heatmap of a location of the subjects over time, a distribution of a number of subjects over time and a distribution of events over time.

In another aspect, in accordance with the teachings herein, there is provided at least one embodiment of a system for processing media data for displaying a media stream comprising a plurality of frames and annotations overlaid on the media stream. The system comprises at least one processor executing a plurality of processor threads, the at least one processor operable to: execute a primary processor thread to: receive media data comprising the media stream and annotation data associated with the plurality of frames; display, via a graphical user interface, the media stream and an annotation output associated with at least a subset of the annotation data retrieved from the buffer, starting on a selected timestamp; and execute at least one of secondary processor thread of a plurality of secondary processor threads to: process the annotation data for the predefined number of frames of the plurality of frames starting on a frame corresponding to the selected timestamp and store the processed annotation data in a buffer associated with the at least one secondary processor thread, wherein processing the annotation data comprises at least accessing a subset of the annotation data.

In at least one embodiment, the media data comprises compressed annotation data and the at least one processor is further operable to execute a secondary processor thread to decompress the media data and transmit the decompressed media data to the primary processor thread, wherein the secondary processor thread is different from the at least one secondary processor thread processing the annotation data.

In at least one embodiment, the at least one processor is operable to: execute the primary processor thread to receive a user selection of the selected timestamp.

In at least one embodiment, the at least one processor is operable to display, by the primary processor thread, via the graphical user interface a timeline of the media stream and wherein the timestamp is selectable on the timeline.

In at least one embodiment, the predefined number of frames is determined based on one or more of: network resources of a network associated with the system, an operating system of the system, the annotation data, a type of the media stream, a frame rate of the media stream a buffer size of the buffer, and a number of frames of the media stream.

In at least one embodiment, the annotation data comprises a plurality of annotation types and the at least one processor is operable to, for each annotation type, execute a separate secondary processor thread to process the annotation data.

In at least one embodiment, the at least one processor is operable to execute the primary processor thread to: receive a selection of one or more types of annotations to be displayed; retrieve, from the buffer the processed annotation data associated with the selected one or more types of annotations; generate the annotation output associated with the selected one or more types of annotations; and display the annotation output.

In at least one embodiment, the at least one processor is operable to execute the primary processor thread to: determine that a current displayed frame of the media stream corresponds to a threshold frame, wherein the threshold frame is indicative that fewer than a predetermined number of the predefined number of frames remain to be displayed; and instruct the at least one secondary processor thread processing the annotation data to process the annotation data for the predetermined number of frames beginning on the threshold frame.

In at least one embodiment, the annotation data comprises identification data identifying objects in the plurality of frames, coordinates of the objects and/or one or more classifications associated with the objects.

In at least one embodiment, the annotation data comprises annotation data for a subset of the plurality of frames and wherein processing the annotation data comprises: retrieving the processed annotation data for frames having associated annotation data; and determining annotation data for frames not associated with annotation data based on the processed annotation data for frames having associated annotation data.

In at least one embodiment, the annotation data is generated by an animal assessment system, a ranch management system or a farm management system.

In at least one embodiment, the media data is collected from one or more imaging devices in communication with the system.

In at least one embodiment, the system is in communication with a computing device comprising a display for displaying the graphical user interface.

In at least one embodiment, the at least one processor is further operable to execute one or more secondary processor threads different from the at least one secondary processor thread processing the annotation data to calculate subject analytics for subjects in the media stream based on the annotation data, the subject analytics comprising one or more of: a heatmap of a location of the subjects over time, a distribution of a number of subjects over time and a distribution of events over time.

In another aspect, in accordance with the teachings herein, there is provided at least one embodiment of a method of receiving, for display on a graphical user interface, a media stream comprising a plurality of frames and annotations overlaid onto the media stream. The method comprises: selecting a location and a time window associated with the media stream to be displayed; receiving the media stream; selecting a timestamp for which the annotations are to be displayed, the timestamp corresponding to a frame of the media stream; selecting one or more annotation types for display; receiving the media stream overlaid with the annotations starting on the selected timestamp, wherein annotation data associated with the annotations is processed according to any of the embodiments of the methods described herein.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1A is a schematic diagram showing an example application of an example animal assessment system that may be used in combination a media data processing system.

FIG. 1B is a schematic diagram showing another example application of the example animal assessment system of FIG. 1A.

FIG. 2 is a block diagram showing an example media data processing system in communication with external components, according to at least one example embodiment.

FIG. 3 is a flowchart showing an example method of processing media data that can be performed by the media data processing system, according to at least one example embodiment.

FIG. 4 shows example annotation data that may be processed by the media processing system of FIG. 2.

FIG. 5 is a display screenshot of an example media player that may be used for displaying media data processed by the media data processing system.

FIG. 6 is another display screenshot of the example media player of FIG. 5.

FIG. 7 is another display screenshot of the example media player of FIG. 5.

FIG. 8 is another display screenshot of the example media player of FIG. 5.

FIG. 9 is another display screenshot of the example media player of FIG. 5.

FIG. 10 is another display screenshot of the example media player of FIG. 5.

FIG. 11 is another display screenshot of the example media player of FIG. 5.

FIG. 12 is another display screenshot of the example media player of FIG. 5.

FIG. 13 is another display screenshot of the example media player of FIG. 5.

Further aspects and features of the example embodiments described herein will appear from the following description taken together with the accompanying drawings.

### DETAILED DESCRIPTION OF THE EMBODIMENTS

Various embodiments in accordance with the teachings herein will be described below to provide an example of at least one embodiment of the claimed subject matter. No embodiment described herein limits any claimed subject matter. The claimed subject matter is not limited to devices, systems or methods having all of the features of any one of the devices, systems or methods described below or to features common to multiple or all of the devices, systems or methods described herein. It is possible that there may be a device, system or method described herein that is not an embodiment of any claimed subject matter. Any subject matter that is described herein that is not claimed in this document may be the subject matter of another protective instrument, for example, a continuing patent application, and the applicants, inventors or owners do not intend to abandon, disclaim or dedicate to the public any such subject matter by its disclosure in this document.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling can have a mechanical or electrical connotation. For example, as used herein, the terms coupled or coupling can indicate that two elements or devices can be directly connected to one another or connected to one another through one or more intermediate elements or devices via an electrical signal, electrical connection, or a mechanical element, depending on the particular context.

Unless the context requires otherwise, throughout the specification and claims which follow, the word “comprise” and variations thereof, such as, “comprises” and “comprising” are to be construed in an open, inclusive sense, that is, as “including, but not limited to”.

Various terms used throughout the present description may be read and understood as follows, unless the context indicates otherwise: singular articles and pronouns as used throughout include their plural forms, and vice versa; similarly, gendered pronouns include their counterpart pronouns so that pronouns should not be understood as limiting anything described herein to use, implementation, performance, etc. by a single gender. Further definitions for terms may be set out herein; these may apply to prior and subsequent instances of those terms, as will be understood from a reading of the present description.

It should also be noted that, as used herein, the wording “and/or” is intended to represent an inclusive-or. That is, “X and/or Y” is intended to mean X or Y or both, for example. As a further example, “X, Y, and/or Z”, and “any combination of X, Y or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by 1%, 2%, 5% or 10%, for example, if this deviation does not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

At least a portion of the example embodiments of the systems or methods described in accordance with the teachings herein may be implemented as a combination of hardware or software. For example, a portion of the embodiments described herein may be implemented, at least in part, by using one or more computer programs, executing on one or more programmable devices comprising at least one processing element, and at least one data storage element (including volatile and non-volatile memory). These devices may also have at least one input device (e.g., a touchscreen, and the like) and at least one output device (e.g., a display screen, a printer, a wireless radio, and the like) depending on the nature of the device.

It should also be noted that some elements that are used to implement at least part of the embodiments described herein may be implemented via software that is written in a high-level procedural language such as object-oriented programming. The program code may be written in JAVA, PYTHON, C, C⁺⁺, Javascript or any other suitable programming language and may comprise modules or classes, as is known to those skilled in object-oriented programming. Alternatively, or in addition thereto, some of these elements implemented via software may be written in assembly language, machine language, or firmware as needed.

At least some of the software programs used to implement at least one of the embodiments described herein may be stored on a storage medium (e.g., a computer readable medium such as, but not limited to, ROM, flash memory, magnetic disk, optical disc) or a device that is readable by a programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions, such as program code, for one or more processors. The program code may be preinstalled and embedded during manufacture and/or may be later installed as an update for an already deployed computing system. The medium may be provided in various forms, including non-transitory forms such as, but not limited to, one or more diskettes, compact disks, DVD, tapes, chips, and magnetic, optical and electronic storage. In alternative embodiments, the medium may be transitory in nature such as, but not limited to, wire-line transmissions, satellite transmissions, internet transmissions (e.g., downloads), media, digital and analog signals, and the like. The computer useable instructions may also be in various formats, including compiled and non-compiled code

Accordingly, any module, unit, component, server, computer, terminal or device described herein that executes software instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of the device or accessible or connectable thereto.

Computer-based animal management systems incorporating imaging devices have recently been introduced, allowing ranchers, and other operators, such as wildlife managers, veterinarians, and other individuals caring for animals to view media captured by imaging devices remotely and asynchronously. Some of these animal management systems include assessment capabilities, allowing animals captured in a media stream (e.g., video stream, image stream, stop-motion image stream) to be identified and classified according to various criteria. These identifications and classifications can be provided to ranchers and other operators.

Processing media and displaying media along with identifications and classifications is however resource intensive, since it requires large volumes of data to be processed, stored, and transmitted. For example, upon receiving data to display along with a media stream, a media player used to display media may need to parse the data to identify the information to be displayed and where the information should be displayed, process the information and store the information until it is displayed. When data is viewed remotely, this process can lead to lags and significant delays before the media stream can be viewed by the user. Moreover, it may not be necessarily a priori clear which pertinent information should be displayed, and how information selected for display should be assembled and displayed into a configuration that is meaningful to the user. Displaying the selected information in a configuration that is meaningful to the user, however, can be important for a user to timely make appropriate management decisions,

The various embodiments described herein can process media data for display in a media player in a manner that is efficient and requires fewer resources when compared to existing systems. As will be described, the disclosed embodiments can require fewer resources, by processing and storing limited portions of received media data at a time.

To minimize delays when processing and storing limited portions of media data at a time, the disclosed embodiments can use multiple dedicated processor threads capable of executing multiple processing tasks concurrently. As will be explained, a primary processor thread can be used for executing core tasks such as receiving media data, storing processed data, and displaying data, while one or more secondary processor threads can be used for executing dedicated tasks, for example, processing data relating to specific types of information to be displayed.

The various embodiments described can be used in combination with various subject assessment systems, including an animal assessment system, that include various models for performing one or more assessments of subjects at a site, for example, animals, plants, crops, vehicles, buildings, humans, etc., for processing and displaying data related to assessments performed by the subject assessment system.

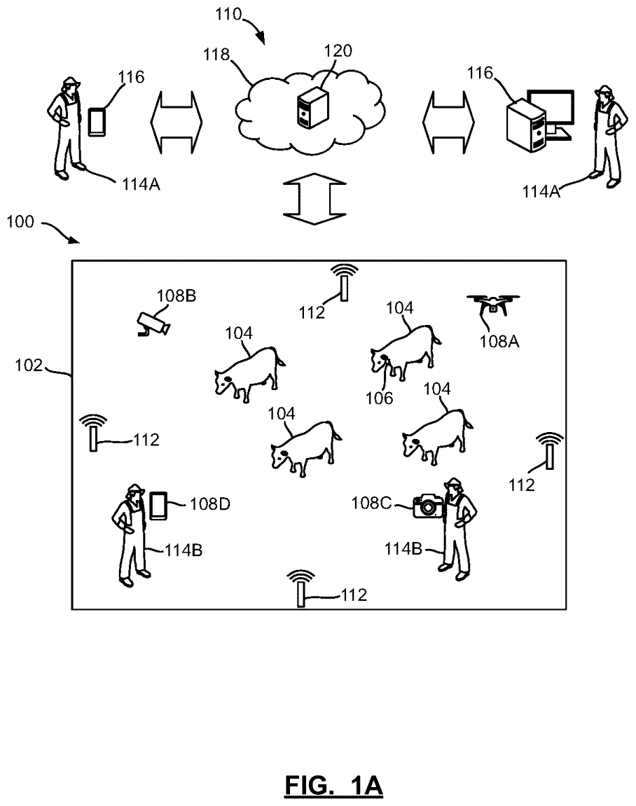

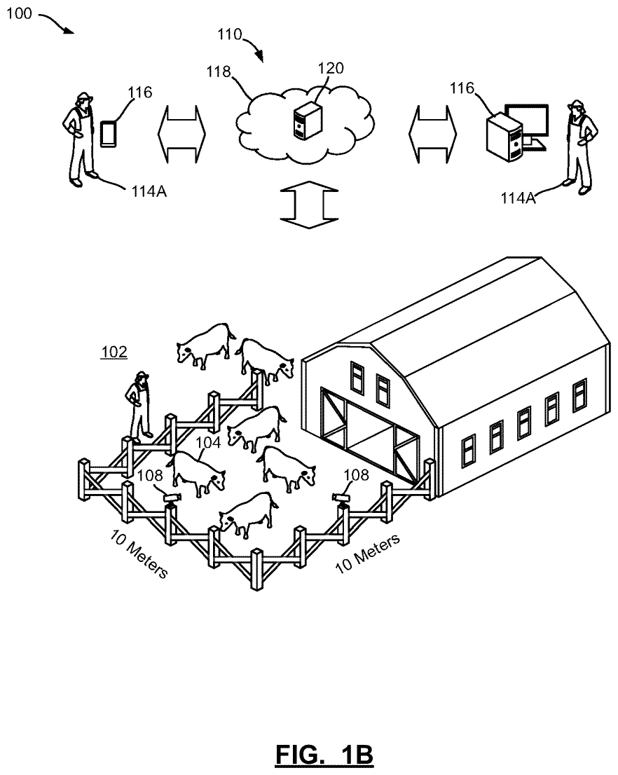

Referring first to FIG. 1A, shown therein is an example animal assessment system 100, according to at least one embodiment of this disclosure that can be used in combination with the systems and methods for processing media data described herein. As described, the various embodiments described herein can be used in combination with subject assessment systems, including an animal assessment system. The animal assessment system 100 is generally associated with a site 102 that includes animals. The site 102 may be an outdoor site, an indoor site, or a site with indoor and outdoor spaces. Furthermore, the site may be an enclosed site, such as a barn, a pen, or a fenced lot, and/or the like, or the site may be open, such as a wildlife park or a natural animal habitat. Examples of the site 102 may be a livestock ranch, a ranch facility, an animal habitat, and/or the like. The site 102 generally comprises a plurality of animals 104 such as livestock (e.g., cows, horses, pigs, sheep, chickens, and/or the like) and/or wild animals (e.g., bison, wolves, elk, bears, goats, elephants, birds, and/or the like). In at least one embodiment, one or more animals 104 may be also associated with an identification (ID) tag 106, such as a visible ID tag attached therewith. As will be described in further detail below, the animal assessment system 100 can be used in combination with the embodiments described herein.

The system 100 comprises one or more imaging devices 108 that are deployed or deployable at the site 102 and are adapted to communicate with a server 120 via a communication network. For example, the imaging devices 108 may communicate with a computer cloud 110 directly or via suitable intermediate communication nodes 112 such as access points, switches, gateways, routers, and/or the like that are deployed at the site 102 or at a site remote to the site 102. In an alternative embodiment, the imaging devices 108 may communicate with a site server 120s that is located at site 102, or remote to the site 102. The site server 120s may then communicate with the server 120, which may be located at the site 102 or remote to the site 102. One or more first users 114A may operate suitable client computing-devices 116 to communicate with the computer cloud 110 for monitoring the animals 104 at the site 102.

Although embodiments have been described above with reference to the accompanying drawings, those of skill in the art will appreciate that variations and modifications may be made.

For example, while the animal assessments are described primarily in terms of cows, it should be understood that these techniques can be applied to other animals by training the various AI models in a somewhat similar fashion using images and other data from the other species.

FIG. 1B shows another example use of the system 100 shown in FIG. 1A. In this example, the site 102 is a fenced site with a barn accessible to the animals 104. One or more fixed imaging devices 108B may be installed at the site 102 such as on the fence. Alternatively, a mobile imaging device, i.e., a drone 108A may be used to t monitor the site 102.

The one or more imaging devices 108 may be any suitable imaging devices such as one or more drones 108A equipped with suitable cameras, one or more surveillance cameras 108B mounted at predefined anchor locations, one or more video cameras 108C movable with and operable by one or more second users 114B such as farmers, researchers, and/or the like, one or more cellphones or smartphones 108D equipped with suitable cameras and movable with and operable by the one or more second users 114B, and/or the like. In at least one embodiment, the first and second users 114A and 114B may be different users while in at least one other embodiment, the first and second users 114A and 114B may be the same users.

Herein, the cameras 108 may be any suitable cameras for capturing any type of media data, (e.g., videos, audio, images) such as any combination of one or more visible-light cameras, one or more infrared (IR) cameras, and/or the like. Depending on the types of the imaging devices 108, the deployment locations thereof, and/or the deployment/operation scenarios (e.g., deployed at fixed locations or movable with the user 114A during operation), the imaging devices 108 may be powered by any suitable power sources such as power grid, batteries, solar panels, Power of Ethernet (POE), and/or the like.

Moreover, the imaging devices 108 may communicate with other devices via any suitable interfaces such as the Camera Serial Interface (CSI) defined by the Mobile Industry Processor Interface (MIPI) Alliance, Internet Protocol (IP), Universal Serial Bus (USB), Gigabit Multimedia Serial Link (GMSL), and/or the like. The imaging devices 108 generally have a resolution (e.g., measured by number of pixels) sufficient for the image processing described later. The imaging devices 108 that are used may be selected such that they are able to acquire images that preferably have a high resolution such as, but not limited to, 720p (1280×720 pixels), 1080p (1920×1080 pixels), 2K (2560×1440 pixels) or 4K (3840×2160 pixels), for example. Some or all imaging devices 108 may have a zoom function. Some or all imaging devices 108 may also have an image stabilization function and motion activated function.

In at least one embodiment, at least one of the imaging devices 108 may be controlled by the system 100 such that the angle, amount of zoom and/or any illumination of the imaging device 108 may be controlled with a server (e.g., server 120 or server 120s) that is associated with system 100. Alternatively, any mobile imaging devices 108b may be controlled to go from one site to another site or to move around larger sites in a controlled manner where the flight path of drone 108A is pre-defined or controlled by a user. In these embodiments, a server (e.g., server 120 or server 120s) of the site that provides these control signals to the imaging devices 108 may do so under program control or under control commands provided by system personnel.

With the hardware and software structures described above, at least one embodiment of the animal assessment system 100 is configured to perform one or more assessments of at least one animal at the site 102. The animal assessment system 100 can be configured to perform assessment(s) of at least one animal based on media captured by the one or more imaging devices 108. For example, the animal assessment system 100 can be configured to perform assessment(s) of at least one animal by processing one or more frames of a video stream captured by the one or more imaging devices, or by processing images captured by the one or more imaging devices.

In particular, the various embodiments of the animal assessment system 100 described herein generally use a multi-layer artificial intelligence (AI) pipeline that is organized among several layers or levels that each have AI models where each level has a unique overarching purpose. The AI models may be implemented using various machine learning algorithms depending on the functionality of the AI models since some machine learning algorithms are better suited than others at performing certain functions. Examples of machine learning algorithms that may be used by the system 100 include, but are not limited, to one or more of Pre-Trained Neural Network (PTNN), Transfer Learning, Convolutional Neural Networks (CNN), Deep Neural Networks (DNN), Deep Convolutional Neural Networks (DCNN), Fully Connected Networks (FCN), Recurrent Neural Networks (RNN), Long Term Short Term (LSTM), Transformer Networks, and/or Pyramid Networks for performing certain functions such as, but not limited to, performing an animal assessment based on its appearance from one or more angles. The neural networks that are used by the system 100 may operate individually or together in a chaining tree. The machine learning algorithms may be trained. At least some of machine-learning models may be trained using a combination of authentic and synthetic images.

Although FIGS. 1A-1B show an animal assessment system 100, it will be understood that the embodiments described herein can be used in combination with any subject assessment system and subject assessment systems can generally include at least some of the same components as the animal assessment system (e.g., imaging devices, servers, AI models, etc.).

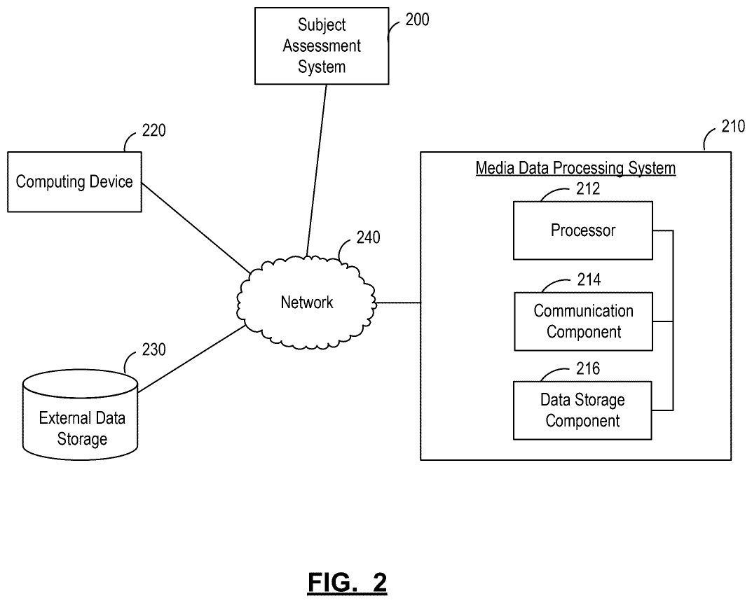

Referring next to FIG. 2, shown therein is a block diagram of a media data processing system 210 in communication with a computing device 220 and an external data storage 230 via a network 240. Although only one computing device 220 is shown in FIG. 2, the media data processing system 210 may be in communication with a greater number of computing devices 106. The media data processing system can communicate with the computing device(s) 106 over a wide geographic area via the network 240. As shown, the media data processing system 210 is in communication with a subject assessment system 200. For example, the media data processing system 210 can receive assessment data from the subject assessment system 200 and receive media data from imaging devices 108 of the subject assessment system 200. The subject assessment system 200 can, for example, be the animal assessment system 100.

The subject assessment system 200 is configured to perform an assessment of at least one subject at a site. The subject assessment system 200 can be configured to generate subject assessment data based on media captured by imaging devices. For example, the subject assessment system 200 can be configured to identify a presence of objects in a media stream or images and perform assessments on the objects identified. In at least one embodiment, the subject assessment system 200 is configured to transmit the media captured and data relating to assessments performed by the subject assessment system 200 to the external data storage 230 and the media data processing system 210 can retrieve the media and the assessment data from the external data storage 230.

For example, as explained with reference to FIGS. 1A-1B, an animal assessment system, such as animal assessment system 100 can be configured to perform an assessment of at least one animal at a site 102. The animal assessment system 100 can be configured to generate animal assessment data based on media captured by imaging devices 108.

The media data processing system 210 includes a data storage component 216, a processor 212, and a communication component 214. The media data processing system 210 can be implemented with more than one computer server distributed over a wide geographic area and connected via the network 240. The data storage component 216, the processor 212 and the communication component 214 may be combined into a fewer number of components or may be separated into further components.

The processor 212 can be implemented with any suitable processor, controller, digital signal processor, graphics processing unit, application specific integrated circuits (ASICs), and/or field programmable gate arrays (FPGAs) that can provide sufficient processing power for the configuration, purposes and requirements of the media data processing system 210. The processor 212 can include more than one processor with each processor being configured to perform different dedicated tasks. The processor 112 can be capable of executing multiple processor threads concurrently.

The communication component 214 can include any interface that enables the media data processing system 210 to communicate with various devices and other systems. For example, the communication component 214 can receive inputs (e.g., user selections) from the computing device 210 and store the inputs in the data storage component 216 or external data storage 230. The processor 112 can then process the inputs according to the methods described herein.

The communication component 214 can include at least one of a serial port, a parallel port or a USB port, in at least one embodiment. The communication component 114 may al-so include an interface to component via one or more of an Internet, Local Area Network (LAN), Ethernet, Firewire, modem, fiber, or digital subscriber line connection. Various combinations of these elements may be incorporated within the communication component 214. For example, the communication component 214 may receive input from various input devices, such as a mouse, a keyboard, a touch screen, a thumbwheel, a trackpad, a track-ball, a card-reader, voice recognition software and the like depending on the requirements and implementation of the media data processing system 210.

The data storage component 216 can include RAM, ROM, one or more hard drives, one or more flash drives, or some other suitable data storage elements such as disk drives. The data storage component 216 can include one or more databases for storing media data, assessment data associated with the media data to be processed, processed media data and/or inputs related to the media data.

The external data storage 230 can store data similar to that of the storage component 216. The external data storage 230 can, in at least one embodiment, be used to store data that is less frequently used and/or older data. The data stored in the external data storage 230 can be retrieved by the computing device 220 and/or the media data processing system 210 via the network 240.

The computing device 220 can include any device capable of communicating with other devices and with the media data processing system 210 through a network such as the network 240. The computing device 220 can include any device capable of receiving user inputs, for example, a user selection and capable of displaying media data on a graphical user interface, including processed media data processed by the media data processing system 210. For example, the computing device 220 can be a device used by a user to view a media stream and obtain information about the media stream. The computing device 220 can include a processor and memory, and may be an electronic tablet device, a personal computer, workstation, server, portable computer, mobile device, personal digital assistant, laptop, smart phone, WAP phone, an interactive television, video display terminals, gaming consoles, and portable electronic devices or any combination of these.

The network 240 can include any network capable of carrying data, including the Inter-net, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling net-work, fixed line, local area network, wide area network, and others, including any combination of these, capable of interfacing with, and enabling communication between, the media data processing system 210, the external data storage 230, and the computing device 220.

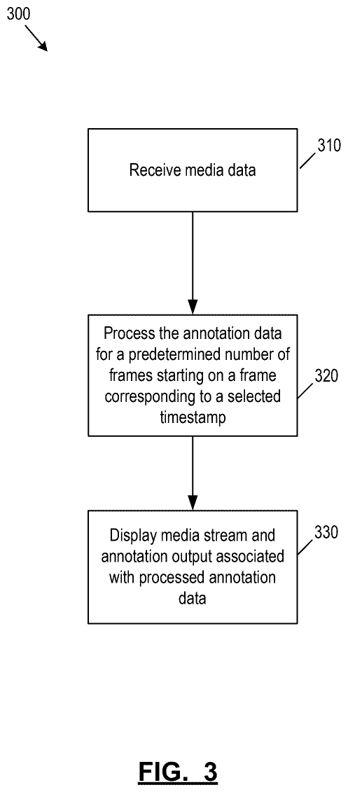

Referring now to FIG. 3, shown therein is a flowchart of an example method 300 of processing media data for display by a media player, according to an embodiment. At least a portion of the media data can be processed in real-time or near real time, as media is displayed by the media player. The media player can have various media player functionalities, such as displaying media content (a media stream), pausing, fast-forwarding, rewinding, zooming, etc. The media player can additionally display annotations overlaid on the media stream, as will be explained in further detail below. Displaying annotations on the media stream can enable users to interact with the media stream and gain insights on the contents of the media stream, e.g., gain insights on subjects present in the media stream. The method 300 can be performed by one or more processors 212 of the media processing system 210, that are capable of concurrently executing multiple processor threads. A processor thread is used in computer concurrent multithreading and can be defined as a virtual software component that executes a sequence of instructions. Processor threads can be distributed across multiple computer cores or can use a single computer core. The processor 212 can accordingly execute multiple operations simultaneously, without the operations impeding each other.

The processor threads can include a primary processor thread and one or more secondary processor threads. The primary processor thread can be used to execute general tasks, including maintaining the user interface and the secondary processor thread(s) can be dedicated to executing specific tasks, including computationally intensive tasks, as will be described in further detail below. The use of multiple processor threads, including dedicated processor threads can allow data to be processed in a more efficient manner and can enable the media data processing system 210 to remain efficient and responsive. By delegating computationally intensive tasks to the secondary processor threads, the primary processor thread can maintain responsiveness in the user interface. The secondary processor threads can access different memory space than the primary processor thread, i.e., the secondary processor threads may not compete with the primary processor thread for the same memory resources.

Prior to method 300 or as part of method 300, the processor 212 can receive a selection of a media stream (e.g., image stream, stop-motion image stream, video stream) for which annotations are desired. For example, a user can access a platform that includes one or more media streams for viewing, and select a media stream for viewing (e.g., by selecting a thumbnail). As another example, a user can access a platform and indicate a location associated with captured media streams and a time window (e.g., date and/or time of day) for which they would like to view annotations.

At step 310, the primary processor thread of the processor 212 receives media data. The media data can be received from a subject assessment system, such as subject assessment system 200. Alternatively, or in addition thereto, the processor 212 can retrieve media data from a data store, for example, the external data storage 130. The media data can include a media stream (e.g., image stream, stop-motion image stream, video stream) that includes a plurality of frames showing images, and annotation data associated with the frames. The media stream can be encoded using any media coding format (e.g., PNG, JPEG, H.264, H.265, etc.). In at least one embodiment, the annotation data is encoded in a JavaScript Object Notation (JSON) format. The plurality of frames can correspond to frames of the video stream as captured by a video capture device or a plurality of images, depending on the type of media stream. In at least one embodiment, the media stream and the annotation data associated with the media stream are received or retrieved separately. In at least one embodiment, the media stream is received prior to method 300, for example, prior to the selection of a media stream for viewing.

In at least one embodiment, the media data is compressed media data to reduce the size of the media data stored/transmitted, i.e., media data can be media data that has been re-encoded into a representation that uses fewer bits than the original representation of the media data to reduce the size of the media data. In such embodiments, if the media stream and the annotation data are received or retrieved separately, the media stream and the annotation data can be received or retrieved as a compressed media stream and compressed annotation data. Alternatively, the media stream and/or the annotation data can be uncompressed. For example, when the annotation data is retrieved from a data store by the processor 212, the annotation data can be uncompressed while when the annotation data is received from a subject assessment system, the annotation data can be compressed. As another example, when the annotation data is associated with an image stream, the annotation data may be uncompressed while when the annotation data is associated with a video stream, the annotation data can be compressed.

The annotation data can be compressed using any text compression technique, including lossless data compression techniques. The media stream can be compressed using any multimedia compression technique.

The annotation data can include data identifying the contents of frames including data derived or generated using an analysis system, for example, the animal assessment system 100, and can correspond to assessment data.

For example, the annotation data for a frame can include an indication that an object is present in the frame, identification data (e.g., identifiers) related to the object, coordinates of the object and/or parts of the object, coordinates associated with the object (e.g., coordinates of a bounding box around the object), classifications related to the object, location and/or time of a captured frame, a size of a frame, and/or any combination of these. The annotation data and the format of the annotation data can vary, depending on the nature of the media stream, the objects present in the media stream and the implementation of the system generating the annotation data. In at least one embodiment, the annotation data includes annotation data for each frame of the media stream. In other embodiments, some frames may not be associated with annotation data. For example, the annotation data may only include annotation data for every N frames (wherein N is an integer from 0 to the number corresponding to the frame rate of media stream), to reduce the size of the annotation data and/or depending on the system generating the annotation data.

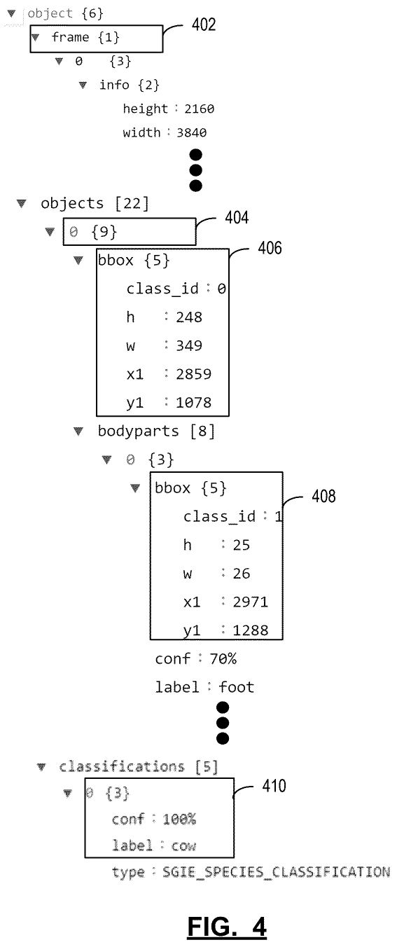

Referring briefly to FIG. 4, shown therein is an example of annotation data that may be received by the media data processing system 210. The annotation data shown in FIG. 4 can be annotation data received from an animal assessment system, such as animal assessment system 100. As shown, the annotation data can include an identification of frames of the media stream (as shown by box 402) and objects in the frame (as shown by box 404). In the example of FIG. 4, annotation data can also include coordinates of a bounding box for each object (as shown by box 406), coordinates of bounding boxes around features of the object (as shown by box 408) and an identification of the feature and classification results for the object (as shown by box 410). FIG. 4 shows annotation data parsed into a specific format for processing by the media data processing system 210. It will be understood that the annotation data received by the media data processing system 210 may or may not be represented in the format shown in FIG. 4.

In embodiments where the media data is compressed, the processor 212 can decompress the media data via a secondary processor thread. Decompressing the media data can involve decoding the compressed media data to obtain the original representation of the media data or a representation of the media data that uses a larger number of bits than the compressed media data. The primary processor thread can transmit the compressed media steam to the secondary processor thread for decompression. For example, the primary processor thread can transmit a binary version of the compressed annotation data to the secondary processor thread. In at least one embodiment, when the decompression is completed, the secondary processor thread transmits the decompressed media stream back to the primary processor thread.

In embodiments where the media stream and the annotation data are retrieved or received separately, the processor 212 can decompress the media stream and the annotation data separately.

In at least one embodiment, the decompressed media data can be preprocessed by the secondary processor thread or by the primary processor thread. For example, the decompressed annotation data can be reformatted, depending on the processing capabilities of the processor 212 or the implementation of the media data processing system 210. In at least one embodiment, at least a portion of the media data is decompressed or formatted after decompression into a string format. A string format can enable faster data transfer, particularly of annotation data containing text, which may be particularly advantageous in embodiments where the processing of annotation is performed in real-time, as will be explained below.

At 320, the processor 212 can process the annotation data of a predetermined limited number of frames via one or more secondary processor threads. The one or more secondary processor threads configured to process the annotation data can be different from the secondary processor thread decompressing the media data at 320. In at least one embodiment, each secondary processor thread is configured to process a different type of annotation data. Processing the annotation data can involve parsing the annotation data received from the primary processor thread and accessing a subset of the annotation data (e.g., a type of annotation data in the annotation data). The types of annotation data can vary depending on the type of media stream with which the annotation data is associated and the system generating the annotation data. For example, if the annotation data includes coordinates of bounding boxes around objects, a classification of the objects and identification data related to the objects, a first secondary processor thread can be used for processing the coordinates of the bounding boxes, a second secondary processor thread can be used for processing the classification of the objects and a third secondary processor thread can be used for processing identification data related to the objects. As another example, if the annotation data relates to animal assessment data, a first secondary processor thread can be used for processing bounding boxes around animals, a second secondary processor thread can be used for processing body parts of animals and a third secondary processor thread can be used for processing key points associated with the animals. The primary processor thread can parse the decompressed annotation data and pass data associated with each type of annotation data to a different secondary processor thread. Alternatively, the primary processor thread can pass the decompressed annotation data to the secondary processor threads and each secondary processor thread can parse the annotation data to process the type of data for which the secondary processor is dedicated.

In at least one embodiment, each secondary processor thread stores the processed annotation data processed by the secondary processor thread in a buffer.

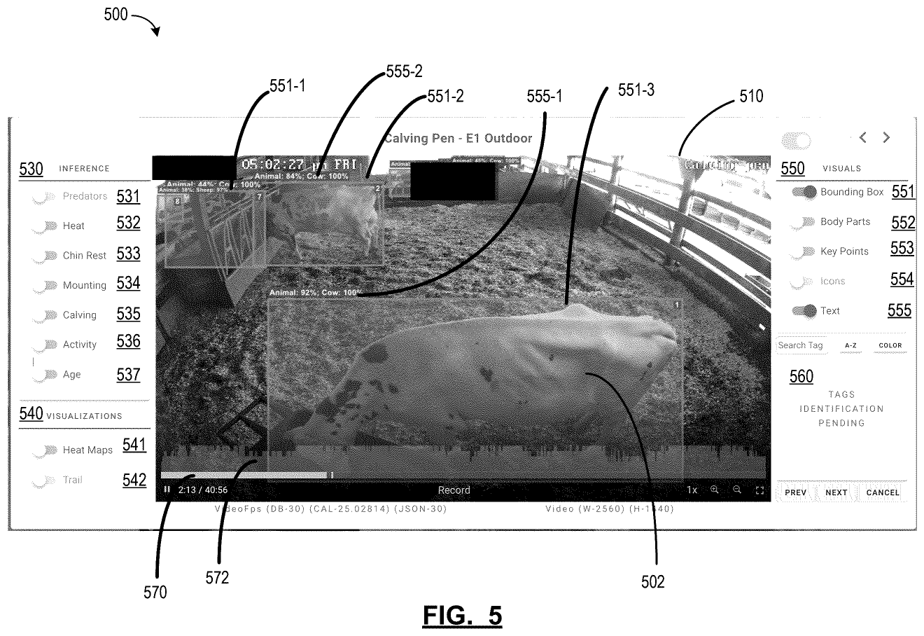

The media data processing system 210 can receive a selection of a start frame or a start time. The media processing system 210 can process the annotation data of the predetermined limited number of frames starting on the selected start frame. For example, a user may want to obtain data about the 25,000^{th} frame of the media stream and select for display an output at the 25,000^{th} frame. In this example, the media processing system 210 can process the annotation data of a predetermined limited number of frames, starting from the 25,000^{th} frame. To process the annotation data, each secondary processor thread can process the type of annotation data for which the secondary processor is dedicated. The secondary processor threads can process the annotation data, in real-time, for example, upon the user selecting a frame for display. Referring briefly to FIG. 5, which shows a screenshot of a media player 500 that may be used in combination with the media processing system 110 for displaying media, the media player 500 can include a timeline and a timeline scrubber 570 that can allow a user to select a start frame or start time timestamp. The start time stamp can be the beginning of the media stream or any other timestamp.

The predetermined limited number of frames can be determined for example, based on the network resources of the network 240, the duration of the media stream, an operating system of the media data processing system 210, the annotation data, the type of media stream, the frame rate of the media stream, the storage capacity of the data storage component 216, or any operable combination of these. For example, the predetermined number of frames can be 10,000, or less. In at least one embodiment, the predetermined limited number of frames is dynamically determined based on the factors above. When the annotation data for the predetermined limited number of frames is processed, the processed annotation data can be returned to the primary processor thread and the primary processor thread can store the processed annotation data in one or more buffers until an output associated with the annotation data is displayed, as will be explained below. Processing the annotation data of a predetermined limited number of frames at a time can reduce the processing resources and the storage requirements required by the media data processing system 210, when compared to processing and storing the annotation data of an entire media stream (when the media stream contains a number of frames that is larger than the predetermined limited number of frames), and thus reduce the required computing and storage resources. Processing the annotation data using dedicated processor threads can allow the annotation data to be processed more rapidly since each processor thread can process a different type of annotation data.

In at least one embodiment, the primary processor thread of the processor 212, stores the processed annotation data of the predetermined limited number of frames, in one or more buffers, for example, one or more buffers in the data storage component 216. For example, the processor 212 can store the processed annotation data received from each secondary processor thread in separate buffers. The buffer(s) can be circular buffer(s). In at least one embodiment where each secondary processor thread stores processed annotation data in a buffer, the buffer associated with each processor thread can be reassigned to the primary processor thread such that the primary processor thread does not need to copy the data in each buffer associated with the secondary processor threads into new buffers associated with the primary processor thread. Transferring ownership of the memory blocks associated with the buffers associated with the secondary processor threads to the primary processor thread rather than copying the contents of the buffers can enable the data transfer process to be sped up. This can be particularly advantageous when large amounts of annotation data are processed.

At 330, the primary processor thread of the processor 212 displays, via a graphical user interface, the media stream and an annotation output associated with the processed annotation data stored in the buffer, starting on the frame corresponding to the selected timestamp. The graphical user interface can correspond to the graphical user interface of the computing device 220. For example, the media data processing system 210 can transmit data for display by the computing device 220 via the network 240. When the predetermined limited number of frames for which annotation data was processed at step 320 have been displayed, the media data processing system 210 can return to step 320 and process the next set of predetermined limited number of frames of the media stream. In at least one embodiment, the processor 212 can automatically begin processing the next set of predetermined limited number of frames of the media stream when a subset of the predetermined limited number of frames have been displayed. For example, if the predetermined limited number of frames is 10,000 the media data processing system 210 can begin processing the next set of predetermined limited number of frames when fewer than 1,000 frames remain to be displayed. Processing the next set of predetermined limited number of frames can involve instructing the secondary processor threads to process the annotation data associated with the next set of predetermined limited number of frames. The processed annotation data of the next set of predetermined limited number of frames can be stored in the buffer and the processed annotation data corresponding to the first set of predetermined limited number of frames can be discarded, or overwritten or partially overwritten with the processed annotation data corresponding to the next set of predetermined limited number of frames. By processing the annotation data of only a predetermined limited number of frames at a time, when the media stream contains a number of frames that is larger than the predetermined limited number of frames, the memory requirements for processing and storing the processed annotation data can be reduced, when compared to processing and storing the annotation data of an entire media stream. Further, the network requirements of network 240 can be reduced, since less data needs be transmitted via the network 240 to the computing device 220.

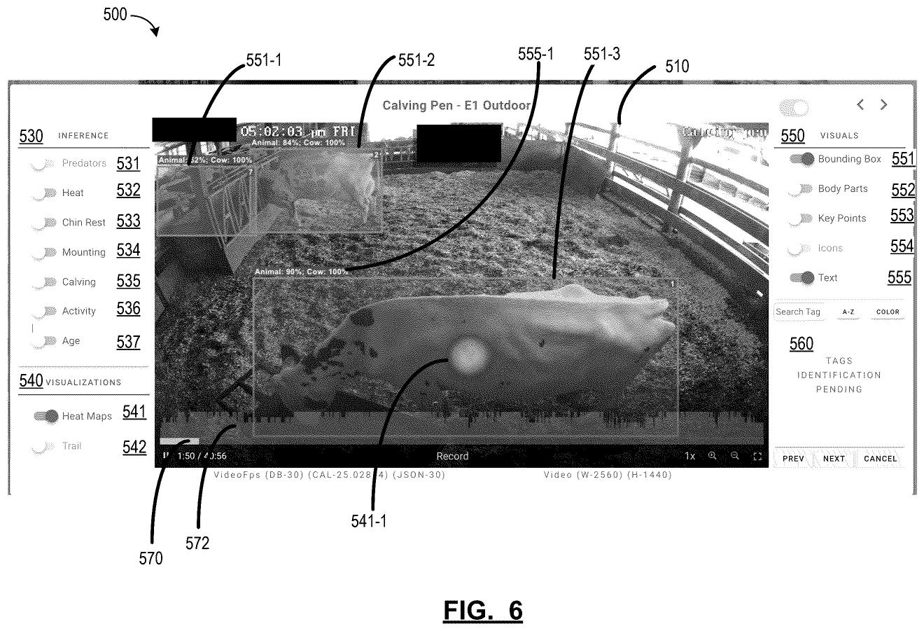

In at least one embodiment, displaying an output based on the processed annotation data stored in the buffer involves processing the processed annotation data by the processor 212. For example, in cases where the processed annotation data includes coordinates, the processor 212 may apply a scaling factor to the coordinates if the resolution of the media viewer is different from the resolution of the original media stream analyzed to generate the annotation data. As another example, if the processed annotation data includes coordinates of the corners of a bounding box around an object and the processor 212 can determine the edges of the bounding box and draw the bounding box when the bounding box is displayed. The processor 212 can employ a secondary processor thread for processing each type of processed annotated data, for example, the processor thread used for processing the processed annotated data at 330. For example, a secondary processor thread configured for processing bounding boxes can be configured to apply the scaling factor to the coordinates of the bounding boxes as parsed by the secondary processor thread. In at least one embodiment, the processing is performed at step 330. The secondary processor thread can then return the output of the processing to the primary processor thread, which can display the output. Other examples will be described below, with reference to FIGS. 5-6.

As described at step 320, in some cases annotation data may not be available for each frame of the media stream. In such cases, the processor 212 can determine annotation data for the frames for which no annotation data is provided, as will be described in further detail with reference to FIG. 5.

Reference is made to FIG. 5 which shows a screenshot of a media player 500 that may be used in combination with the media processing system 110 for displaying media. As shown in FIG. 5, the media player 500 can include a video image viewer 510 for viewing the media stream and various panels 530, 540, 550, 560 for selecting information to be displayed in the video image viewer 510.

In the example screenshot of FIG. 5, the media player 500 includes an object state panel 530 indicating a state of objects in a media stream, visual annotation panels 540, 550 for displaying visual aids and an object identification panel 560 identifying objects present in the media stream. Though FIG. 5 shows an object state panel 530, visual annotation panels 540, 550 and an object identification panel 560, it will be understood that the media player 500 can include any number of panels and that the panels can be used for displaying other types of information within the media player 500, depending on the system from which annotation data is generated, the media stream and the implementation of the media data processing system 210.

The panels can include selectable filters (e.g., predators 531, heat 532, chin rest 533, mounting 534, calving 535, activity 536, age 537, heat maps 541, trail 542, bounding box 551, body parts 552, key points 553, icons 554, text 555) that when selected, cause a visual output to be displayed within the media viewer 510. For example, the selectable filter can include toggle switches, as shown in FIG. 4 that can toggle between an “ON” position, where a visual output associated with the selected toggle switch is displayed in the media viewer 510 and an “OFF” position, where no visual output associated with the selected toggle switch is displayed. The selectable filters can be associated with the annotation data.

When a selectable filter is selected, the processor 212 of the media data processing system 210 can select or determine a visual output associated with the selected filter to be displayed within the media viewer 510 of the media player 500. As explained, the primary processor thread can be configured for generating and displaying the visual output. The visual output to be displayed can correspond to a visual representation of the processed annotation data associated with the selected selectable filter. For example, as shown in FIG. 5, when the selectable filter “bounding box” and “text” are selected, bounding boxes 551 and accompanying text 555 are shown in the media viewer 510. To display the bounding boxes 551, for each frame, the processor 212 can retrieve from the buffer processed annotation data corresponding to the location (e.g., coordinates) of bounding boxes associated with each object 502 and generate and display bounding boxes in the media viewer 510 based on the retrieved location of the bounding boxes. To display the text 555, for each frame, the processor 212 can retrieve the annotation data corresponding to the text and optionally, the location of the bounding boxes and display the text, for example, above the bounding box. Alternatively, to display the text 555, for each frame, the processor 212 can retrieve annotation data corresponding to assessments made the animal assessment system 100 and generate text based on the annotation data corresponding to the assessments. For example, the annotation data can indicate that a given media frame includes an object, that the object corresponds to an animal, and specifically a cow. In such an example, the processor 212 can determine that the text “animal, cow” is to be displayed and display the text “animal, cow”.

In at least one embodiment, the processor 212 determines the visual output associated with annotation data to be displayed only when selectable filters are selected and only for the particular selectable filters selected. For example, the processor 212 can retrieve the processed annotation data corresponding to the location of bounding boxes only when the selectable filter “bounding box” is selected. That is, the processor 212 can determine the visual output associated with annotation data to be displayed in real time. In other embodiments, the processor 212 can determine the visual output to be displayed for each type of annotation in the annotation data at 330. In such embodiments, at 350, the processor 212 can select for display the visual outputs corresponding to the selectable filter selected.

As described with reference to method 300, in some cases, annotation data may not be available for each frame of the media stream. In such cases, the processor 212 can determine annotation data for the frames for which no annotation data is provided based on existing annotation data. For example, the annotation data can include annotation data corresponding to the location of bounding boxes for each N frames (e.g., 30, 60 frames). To provide visual continuity boxes, the processor 212 can calculate the location of bounding boxes for frames for which no annotation data is available based on the location of bounding boxes for frames for which annotation data is available. For example, the processor 212 can interpolate the location of a bounding box for which no annotation data is available based on the location of bounding boxes for frames for which annotation data is available (e.g., a previous frame for which annotation data is available and a subsequent frame for which annotation is available). In at least one embodiment, each secondary processor thread can determine annotation data for the frames for which no annotation data is provided, for the type of annotation data for which the secondary processor thread is dedicated. For example, a secondary processor thread configured for processing bounding boxes can determine coordinates of bounding boxes for frames for which no bounding box data is provided.

Reference is next made to FIG. 6, which shows another screenshot of the media player 500. As shown in FIG. 6, when the selectable inputs “heatmap” 541, “bounding box” 551, “text” 555 and are selected, one or more heatmaps 541 associated with one or more objects, bounding boxes 551 and accompanying text 555 are shown in the media viewer 510. To display the heatmaps, for each frame, the processor 212 can retrieve annotation data corresponding to heatmaps from the buffer and display the heatmaps 541. Alternatively, in at least one embodiment s, the processor 212 can generate the heatmaps based on annotation data indicating the location of the objects.

For example, based on annotation data indicating a position of an object (e.g., a center point of an object or its bounding box), the processor 212 can track the position of the object over a plurality of frames and generate a heatmap indicative of the position of the object over time. The processor 212 can for example, assign intensity values to pixels based on a location of the object (e.g., as determined by the center point of the object or its bounding box) over time (i.e., iteratively, over a plurality of frames) to generate a heatmap, where pixels corresponding to the most frequently occurring position of the object are assigned higher intensity values. One or more processor threads can be used for generating the heatmaps. For example, one or more secondary processor threads can be used for calculating information relating to the heatmaps and the primary processor thread can be used for generating the visual representation of the heatmaps. In at least one embodiment, the primary processor thread parses the annotation data, for example, the decompressed annotation data received at 320 and transmits the parsed data to one or more secondary processor threads. For example, the primary processor thread can transmit the parsed data at step 320. The secondary processor threads configured to compute analytics such as heatmaps can be different from the secondary processor threads used at step 330. In at least one embodiment, the secondary processor threads configured to compute analytics can process the data received from the primary processor thread when the secondary processor threads receive the data and for the entire length of the media stream, i.e., the analytics may not be computed in real-time (i.e., upon selection of a frame for display by a user). In at least one embodiment, the secondary processor threads configured to compute analytics can transmit the analytics computed to the primary processor thread or a buffer accessible by the primary processor thread and terminate upon completion of the analytics computation.

In at least one embodiment, bounding boxes 551 displayed in the media viewer 510 can be selectable. For example, some visual outputs may only be displayed when the bounding box for which the visual output is desired is selected. For example, as shown in FIG. 6, heatmap 541-1 may only be displayed when the bounding box 551-3 is selected and the processor 212 may only compute the heatmaps for the bounding boxes selected.

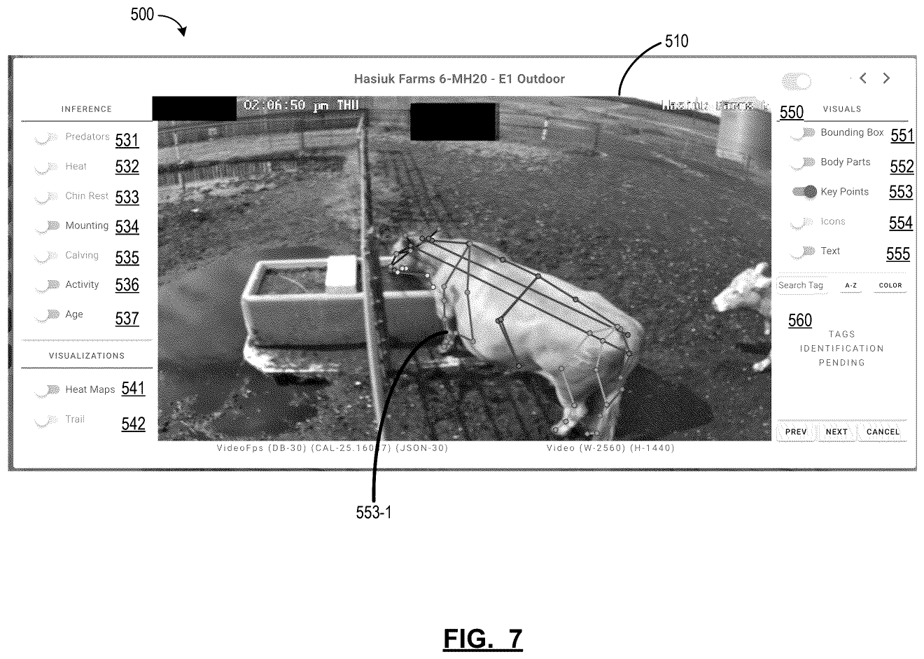

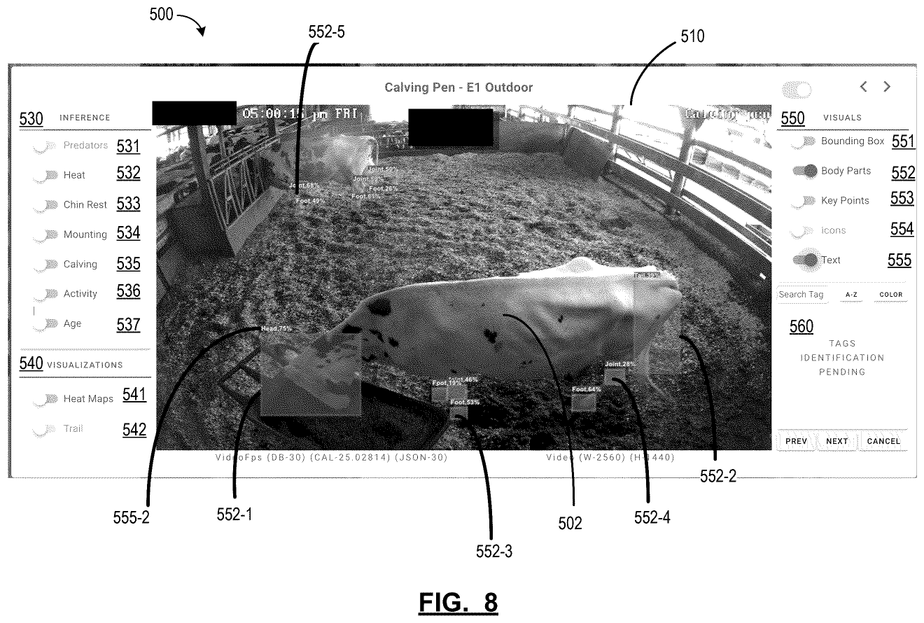

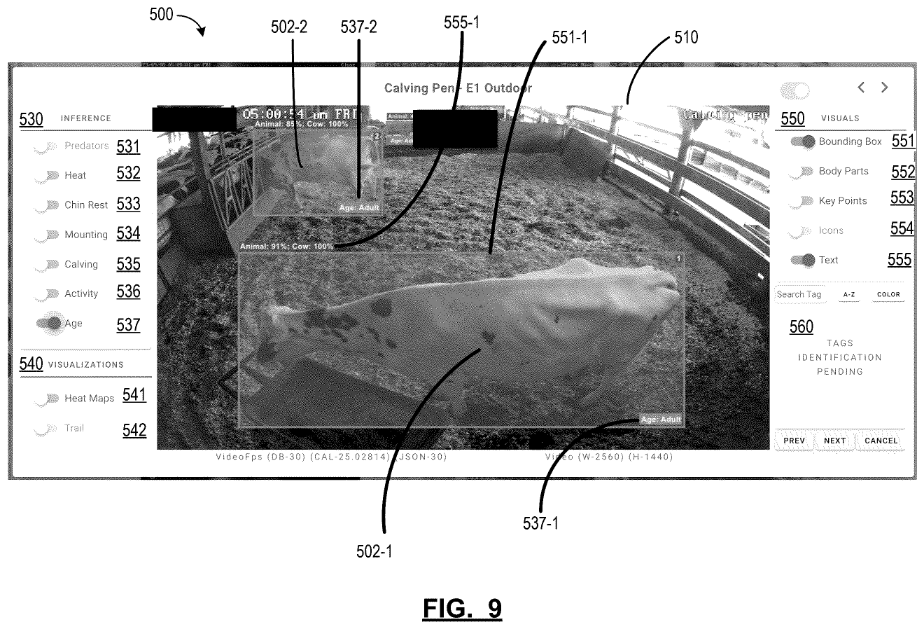

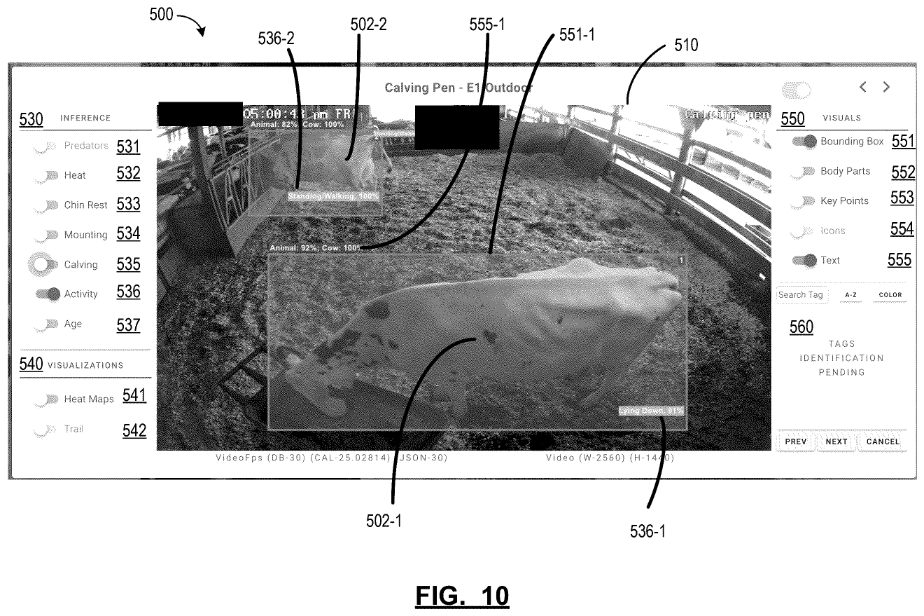

Reference is next simultaneously made to FIGS. 7-10 which show other screenshots of the media player 500. As shown, FIG. 7 shows the media player 500 when the selectable input “key points” 553 is selected. Similar to the selectable inputs described with reference to FIGS. 5 and 6, to display the key points, the processor 212 can retrieve the annotation data corresponding to the location (e.g., coordinates) of the key points associated with each frame, from the buffer and display a visual representation of the key points 553-1 in the media viewer 510, based on the retrieved location of the key points. Similarly, to display the body parts 552 in FIG. 8, the processor 212 can retrieve annotation data corresponding to the location (e.g., coordinates) of body parts for each frame, from the buffer, and display a visual output identifying the body parts, for example, the processor 212 can generate boxes around the body parts identified 555. As described, the body parts can be determined by an animal assessment system 100 in communication with the media data processing system 210. Similarly, to display the age 537 of each object 502 as shown in FIG. 9, the processor 212 can retrieve annotation data corresponding to the age of each object for each frame, from the buffer, and display a visual output identifying the age of the object. As described, the age of each object can be determined by an animal assessment system 100 in communication with the media data processing system 210. Similarly, to display the activity 536 of each object 502, the processor 212 can retrieve annotation data corresponding to the activity of each object 502 for each frame, from the buffer, and display a visual output identifying the activity of the object. As described, the activity of each object can be determined by an animal assessment system 100 in communication with the media data processing system 210.

In at least one embodiment, the processor 212 is configured to generate a graphical representation representing the distribution of objects over time as shown by density graph 572. For example, for each frame, the processor 212 can determine the number of objects in the frame and generate a graph, where the x-axis represents the frame number, and the y-axis represents the number of objects in the frame. The number of objects in the frame can be determined based on the annotation data. For example, the annotation data can identify each object in a frame and/or the number of objects in a frame. One or more secondary processor threads configured for computing analytics as described above can be used for determining the distribution of objects over time and the primary processor thread can be used for rendering the graphical representation representing the distribution of objects.

Though FIGS. 5-10 only show a limited number of visual outputs displayed in the media viewer 510, it will be understood that any number of visual outputs can be displayed in the media viewer 510.

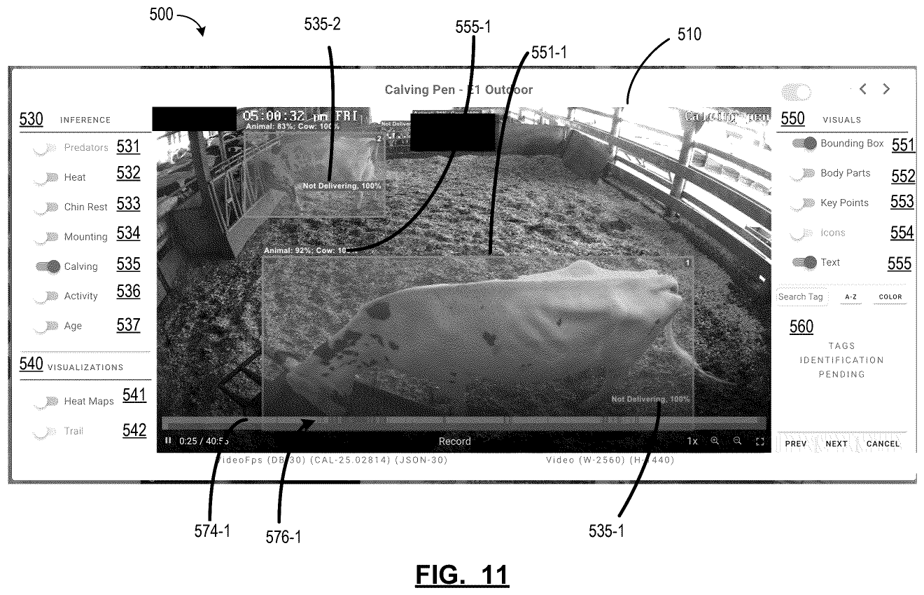

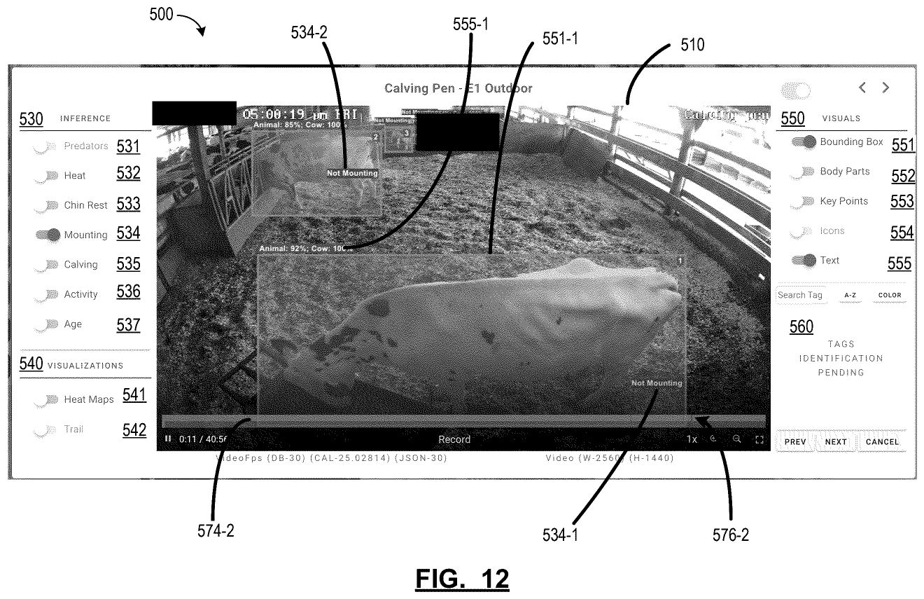

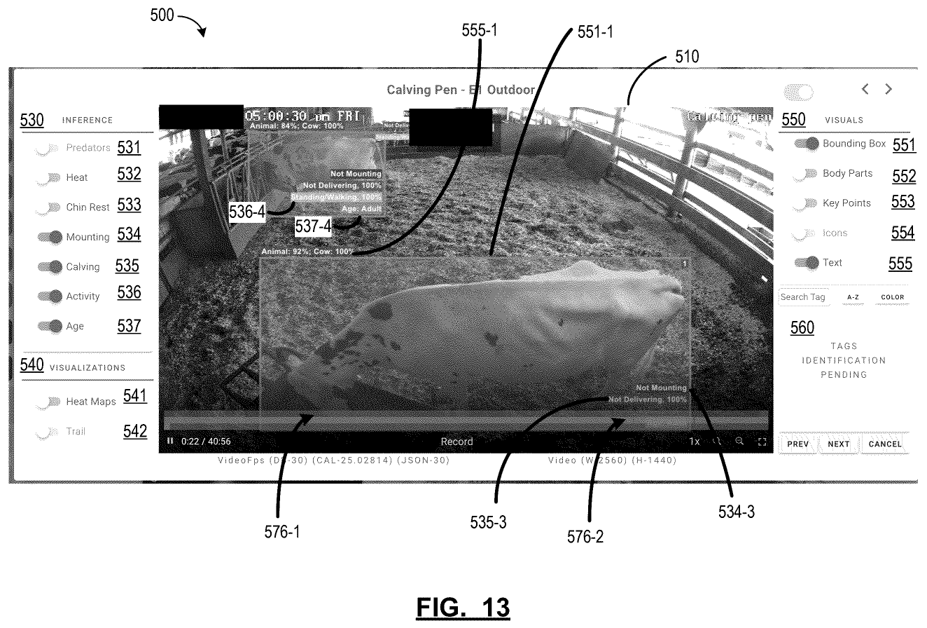

In at least one embodiment, as shown in FIG. 11, the media player 500 includes one or more timelines of events 574 for displaying when events corresponding to a selectable filter occurs. In the example shown in FIG. 11, when the calving 535 selectable filter is selected, a timeline 574 of calving events is displayed. The timeline 574 can indicate portions of the media (e.g., frames) that are associated with calving events, as indicated in the annotation data. For example, the annotation data can indicate that certain frames of the media stream include a calving event and the processor 212 can display a visual annotation 576 on the timeline 574 identifying these frames. FIG. 12 shows another example, when the selectable input mounting 534 is selected. As shown in FIG. 13, multiple timelines 574 can be displayed, depending on the selectable inputs selected. In at least one embodiment, the processor 212 can execute a separate secondary processor thread for each timeline 574. For example, to generate a timeline 574, a secondary processor thread can retrieve annotation data corresponding to the event from a buffer, identify frames associated with the event and generate a timeline indicating portions of the media stream associated with the event. The secondary processor thread can be a secondary processor thread configured for computing analytics as described above.

Although embodiments have been described above with reference to the accompanying drawings, those of skill in the art will appreciate that variations and modifications may be made.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. A method for processing media data for displaying a media stream comprising a plurality of frames and annotations overlaid on the media stream, the method comprising:
operating at least one processor executing a plurality of processor threads to:
receive, by a primary processor thread, media data comprising the media stream and annotation data associated with the plurality of frames;
process, by at least one secondary processor thread of a plurality of secondary processor threads, the annotation data for a predefined number of frames of the plurality of frames starting on a frame corresponding to a selected timestamp, and store the processed annotation data in a buffer associated with the at least one secondary processor thread, wherein processing the annotation data comprises at least accessing a subset of the annotation data; and
display, by the primary processor thread, via a graphical user interface, the media stream and an annotation output associated with at least a subset of the annotation data retrieved from the buffer, starting on the selected timestamp.

2. The method of claim 1, wherein the media data comprises compressed annotation data and wherein the at least one processor is further operable to execute a secondary processor thread of the plurality of secondary processor threads to decompress the media data and transmit the decompressed media data to the primary processor thread, wherein the secondary processor thread decompressing the media data is different from the at least one secondary processor thread processing the annotation data.

3. The method of claim 1, further comprising operating the at least one processor to:
receive, by the primary processor thread, a user selection of the selected timestamp.

4. The method of claim 1, wherein the predefined number of frames is determined based on one or more of: network resources of a network associated with a system implementing the method, an operating system of the system, the annotation data, a type of the media stream, a frame rate of the media stream a buffer size of the buffer, and a number of frames of the media stream.

5. The method of claim 1, wherein the annotation data comprises a plurality of annotation types, and wherein the method further comprises, for each annotation type, processing the annotation data by a separate secondary processor thread.

6. The method of claim 1, further comprising operating the at least one processor to:
receive a selection of one or more types of annotations to be displayed;
retrieve, from the buffer the processed annotation data associated with the selected one or more types of annotations;
generate the annotation output associated with the selected one or more types of annotations; and
display the annotation output.

7. The method of claim 1, further comprising operating the at least one processor to:
determine, by the primary processor thread, that a current displayed frame of the media stream corresponds to a threshold frame, wherein the threshold frame is indicative that fewer than a predetermined number of the predefined number of frames remain to be displayed; and
instruct the at least one secondary processor thread processing the annotation data to process the annotation data for the predetermined number of frames beginning on the threshold frame.

8. The method of claim 1, wherein the annotation data comprises identification data identifying objects in the plurality of frames, coordinates of the objects and/or one or more classifications associated with the objects.

9. The method of claim 1, wherein the annotation data comprises annotation data for a subset of the plurality of frames and wherein processing the annotation data comprises:
retrieving the processed annotation data for frames having associated annotation data; and
determining annotation data for frames not associated with annotation data based on the processed annotation data for frames having associated annotation data.

10. The method of claim 1, further comprising operating the at least one processor to calculate, by one or more secondary processor threads different from the at least one secondary processor thread processing the annotation data, subject analytics for subjects in the media stream based on the annotation data, the subject analytics comprising one or more of: a heatmap of a location of the subjects over time, a distribution of a number of subjects over time and a distribution of events over time.

11. A system for processing media data for displaying a media stream comprising a plurality of frames and annotations overlaid on the media stream, the system comprising at least one processor executing a plurality of processor threads, the at least one processor being operable to:
execute a primary processor thread to:
receive media data comprising the media stream and annotation data associated with the plurality of frames;
display, via a graphical user interface, the media stream and an annotation output associated with at least a subset of the annotation data retrieved from the buffer, starting on a selected timestamp; and
execute at least one of secondary processor thread of a plurality of secondary processor threads to:
process the annotation data for the predefined number of frames of the plurality of frames starting on a frame corresponding to the selected timestamp and store the processed annotation data in a buffer associated with the at least one secondary processor thread, wherein processing the annotation data comprises at least accessing a subset of the annotation data.

12. The system of claim 11, wherein the media data comprises compressed annotation data and wherein the at least one processor is further operable to execute a secondary processor thread to decompress the media data and transmit the decompressed media data to the primary processor thread, wherein the secondary processor thread is different from the at least one secondary processor thread processing the annotation data.

13. The system of claim 11, wherein the at least one processor is operable to:
execute the primary processor thread to receive a user selection of the selected timestamp.

14. The system of claim 11, wherein the predefined number of frames is determined based on one or more of: network resources of a network associated with the system, an operating system of the system, the annotation data, a type of the media stream, a frame rate of the media stream a buffer size of the buffer, and a number of frames of the media stream.

15. The system of claim 11, wherein the annotation data comprises a plurality of annotation types, wherein the at least one processor is operable to, for each annotation type, execute a separate secondary processor thread to process the annotation data.

16. The system of claim 11, wherein the at least one processor is operable to execute the primary processor thread to:
receive a selection of one or more types of annotations to be displayed;
retrieve, from the buffer the processed annotation data associated with the selected one or more types of annotations;
generate the annotation output associated with the selected one or more types of annotations; and
display the annotation output.

17. The system of claim 11, wherein the at least one processor is operable to execute the primary processor thread to:
determine that a current displayed frame of the media stream corresponds to a threshold frame, wherein the threshold frame is indicative that fewer than a predetermined number of the predefined number of frames remain to be displayed; and
instruct the at least one secondary processor thread processing the annotation data to process the annotation data for the predetermined number of frames beginning on the threshold frame.

18. The system of claim 11, wherein the annotation data comprises identification data identifying objects in the plurality of frames, coordinates of the objects and/or one or more classifications associated with the objects.

19. The system of claim 11, wherein the annotation data comprises annotation data for a subset of the plurality of frames and wherein processing the annotation data comprises:
retrieving the processed annotation data for frames having associated annotation data; and
determining annotation data for frames not associated with annotation data based on the processed annotation data for frames having associated annotation data.

20. The system of claim 11, wherein the at least one processor is further operable to execute one or more secondary processor threads different from the at least one secondary processor thread processing the annotation data to calculate subject analytics for subjects in the media stream based on the annotation data, the subject analytics comprising one or more of: a heatmap of a location of the subjects over time, a distribution of a number of subjects over time and a distribution of events over time.
